(19) United States
(12) Patent Application Publication
(10) Pub. No.: US 2025/0313032 A1
(43) Pub. Date: Oct. 9, 2025

(54) VERTICALLY MOUNTABLE HORIZONTALLY ORIENTABLE DOCUMENT CONTAINER

(71) Applicant: J.B. Hunt Corp., Lowell, AR (US)

(72) Inventors: Marlene K. Long, Springdale, AR (US); John Keith Stevens, Orland Park, IL (US); Tyler B. Lippincott, Cave Springs, AR (US); Jake H. Sherman, Chicago, IL (US)

(73) Assignee: J.B. Hunt Corp., Lowell, AR (US)

(21) Appl. No.: 19/169,573

(22) Filed: Apr. 3, 2025

Related U.S. Application Data
(60) Provisional application No. 63/575,007, filed on Apr. 5, 2024.

(51) Int. Cl. B42F 15/00; B42F 7/14

(52) U.S. Cl. CPC B42F 15/0011; B42F 7/145

(57) ABSTRACT

A vertically mountable and horizontally orientable document container for mounting on a surface. The container includes a base, a cover, and a latch. The base has a base wall and four perimeter walls extending away from the base wall. The cover has a cover wall and three perimeter walls extending away from the cover wall. The cover slidingly engages with the base and matingly fits over the base to form a document storage chamber. Each of the cover three perimeter walls forms a primary-grooved channel, and the base is in fitted-sliding engagement with the cover. The latch is formed by the base and the cover as a catch and a lever. The lever snap-fits together with the catch to secure the cover in a temporarily locked position when the cover is located covering the base and providing an environmentally-secure zone in the document storage chamber.

### CROSS-REFERENCE TO RELATED APPLICATIONS

This application claims the benefit of U.S. Provisional Application No. 63/575,007, filed Apr. 5, 2024, and titled: “VERTICALLY MOUNTABLE HORIZONTALLY ORIENTABLE DOCUMENT CONTAINER.”

### TECHNICAL FIELD

This invention generally relates to a manifest storage container. More specifically, this relates to a vehicle mountable, manually operated, sliding open and closed manifest container for storing documents that can be selectively accessed, and all while protecting the documents from the elements of nature like rain, snow, wind, and outer environment elements that could damage the documents.

### BACKGROUND

There exist a variety of manifest storage containers, and particularly vehicle mounted containers, that attempt to make document storage and accessibility easy and/or quick. One common deficiency with all known containers is their lack of durability. Additionally, existing containers do not automatically close and lock. Their clam shell design requires users to manually close and latch. This feature results in improper latching and damage to both the container and its contents. Proper use of existing containers often requires users to remove gloves or hand coverings to properly operate the latching/locking devices which creates safety issues. Existing containers with a hinged design are prone to open when subjected to the winds that occur at highway speeds. Thus, as best the inventors can determine, no existing manifest storage containers, or methods related thereto, enable the quality and efficient means provided for by, and when using, the manifest storage container of the present disclosure.

### SUMMARY

To address one or more deficiencies in the art and/or better achieve the desirable requirements for a document container and safeguarding its contents from an environment outside the container, and in particular wind and water outside the container, there is provided a vertically mountable and horizontally orientable document container for mounting on a surface. The container includes a base, a cover, and a latch. The base has a base wall and four perimeter walls extending away from the base wall and including a pair of spaced apart base length-walls located in between a pair of spaced apart base width-walls, the base is configured for attachment to the surface within an outline of the four perimeter walls. The cover has a cover wall and three perimeter walls extending away from the cover wall with a pair of cover width-walls spaced apart by a cover length-wall therebetween, the cover is sized and configured to slidingly engage with a perimeter of the base and matingly fit over the base to form a document storage chamber between the base and the cover. Each of the cover three perimeter walls has a bottom edge portion extending toward a center of the cover and forming a primary-grooved channel in each of the three perimeter walls. The base width-walls are sized and configured for fitted-sliding engagement with the primary-grooved channel in each of the cover width-walls. The latch is formed by the base and the cover and includes a catch and a lever. The lever snap-fits together with the catch to secure the cover in a temporarily locked position when the cover is located covering the base and providing an environmentally-secure zone in the document storage chamber.

In other aspects, there is disclosed additional structures for mating and fitted relationship between the base and the cover, as well as structure and ways to make the container more environmentally-secure within the container, including ridges and grooves, as well as press-fit relationships.

In still other aspects, there is disclosed structure and ways to make opening and closing the container easier and/or more user friendly, and helping prevent the container from disassembly unintentionally.

The terms “comprising,” “including,” “having” and their derivatives are not intended to exclude the presence of any additional component, step, or procedure, whether or not the same is specifically disclosed. In order to avoid any doubt, all compositions claimed through use of the term “comprising” may include any additional additive, adjuvant, or compound unless stated to the contrary. In contrast, the term “consisting essentially of” excludes from the scope of any succeeding recitation any other component, step, or procedure, excepting those that are not essential to operability. The term “consisting of” excludes any component, step or procedure not specifically delineated or listed.

### DESCRIPTION OF THE DRAWINGS

The invention may be more completely understood in consideration of the following detailed description of various features of the invention in connection with the accompanying drawings, in which:

FIG. 1 shows a top front perspective view of a vertically mountable and horizontally orientable document container of this disclosure, with a cover in a fully open position;

FIG. 2 shows a top view of that seen in FIG. 1;

FIG. 3 shows a top front perspective view of that seen in FIG. 1, but with the cover in a fully closed and temporarily locked position;

FIG. 4 shows bottom side perspective view of that seen in FIG. 3;

FIG. 5 shows a cut away front view taken along the line 5-5 of that seen in FIG. 1;

FIG. 6 shows an enlarged portion of that seen in FIG. 5 and labeled as 6;

FIG. 7 shows a top front perspective view of just the cover seen in FIG. 1;

FIG. 8 shows a bottom side perspective view of that seen in FIG. 7;

FIG. 9 shows a top front perspective view of just the base seen in FIG. 1; and

FIG. 10 shows a bottom side perspective view of the base seen in FIG. 9.

The drawings show some but not all aspects. The elements depicted in the drawings are illustrative and not necessarily to scale, and the same (or similar) reference numbers denote the same (or similar) features throughout the drawings, though all the same (or similar) features are not always separately numbered to help avoid over numbering and obscuring what the drawings are disclosing.

### DETAILED DESCRIPTION

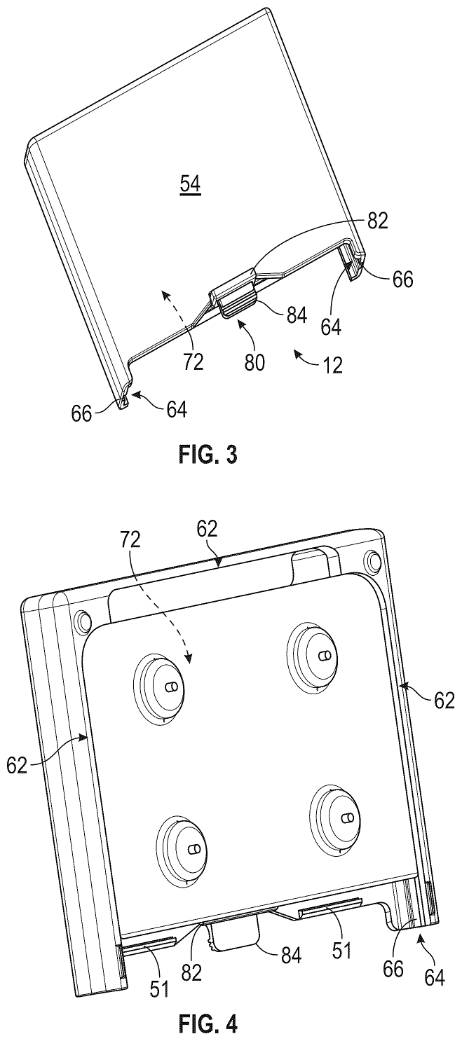

In accordance with the practice of our innovative document container, for example as depicted in the Figs, there is seen a vertically mountable and horizontally orientable document container 10 for mounting on a surface 20. For example, the surface 20 can be the side of a vehicle or carrier hauled by a vehicle, like a semi-tractor and its trailer. And additionally, such mounting location is often against the front/nose of the trailer, and there is limited space for container 10, especially in terms of a thickness 14 of the container. For example, in combination with further explanation, the thickness of the container can be, preferably, no greater than 50 millimeters when the cover is in the temporarily locked position, and is preferably no more than 40 millimeters thick in the locked position and even more preferably no more than 30 millimeters thick in the locked position. Related to this preferred thickness of container 10, and generally included within its parameter, and as will become more clear hereafter, preferably the base has at least one foot 37 and the foot 37 is shaped and configured to create a gap 38 between a bottom edge portion 62 of the cover and the surface 20. Even more particularly, in use, the container 10 is vertically mounted so vertical direction 16 corresponds to the vertical side of a semi-tractor trailer wall and is referred to herein as surface 20. Further, the orientation of container 10 is preferably in horizontally oriented direction 18, which means the length of container 10 corresponds with direction 18. Further in this regard, a sheet of paper or document measuring 8.5 inches by 11 inches, would be storable and stored in the container in a so-called landscape orientation. Via base 30, container 10 can be secured to surface 20 by one or more attaching pin, bolt, rivet, or relatable mechanical structure 31, including adhesive. Container 10 includes a base 30 having a base wall 32 and four perimeter walls extending away from the base wall. The four perimeter walls can be a pair of spaced apart base length-walls 40 and 41 located in between a pair of spaced apart base width-walls 46 and 47. The base is configured for attachment to the surface 20 within an outline of the four perimeter walls 40, 41, 46 and 47. Container 10 further includes a cover 50 having a cover wall 54 and three perimeter walls extending away from the cover wall. The three perimeter walls can be a pair of cover width-walls 58 and 59 spaced apart by a cover length-wall 60 therebetween. The cover is sized and configured to slidingly engage with a perimeter of the base and matingly fit over the base to form a document storage chamber 70 between the base 30 and the cover 50. Each of the cover three perimeter walls 58, 59 and 60 has a bottom edge portion 62 extending toward a center 52 of the cover and forming a primary-grooved channel 64 in each of the three perimeter walls. The base width-walls 46 and 47 are sized and configured for fitted-sliding engagement with the primary-grooved channel in each, respective, cover width-walls. A latch 80 is formed by the base 30 and the cover 50 and can be a catch 82 that receives a lever 84. Preferably, the lever 84 snap-fits together with the catch 82 to secure the cover 50 in a temporarily locked position 12 (FIGS. 3 and 4) when the cover is located covering the base (i.e., generally fully covering the base) and providing an environmentally-secure zone 72 in the document storage chamber 70. While the catch is depicted as part of the base 30, and the lever 84 on the cover 50, the relationship of catch and lever could be reversed and still obtain the functional capabilities of the latch 80 needed here.

Without being limited to a theory of understanding, the inventors have discovered it is a tight capability window to obtain both an environmentally-secure zone desired for the document storage chamber and yet still enable the container with cover and base to be opened and closed efficiently and effectively, especially doing so over and over and over during the anticipated life of container 10. Thus, it is each feature alone, and even more preferably certain of these features in combination with one or more other feature, related to the size, configuration, sliding, fitted-sliding, and/or mating fit of parts relative to one another, that leads to the innovative container 10 being constructed and functioning unlike any known prior document container.

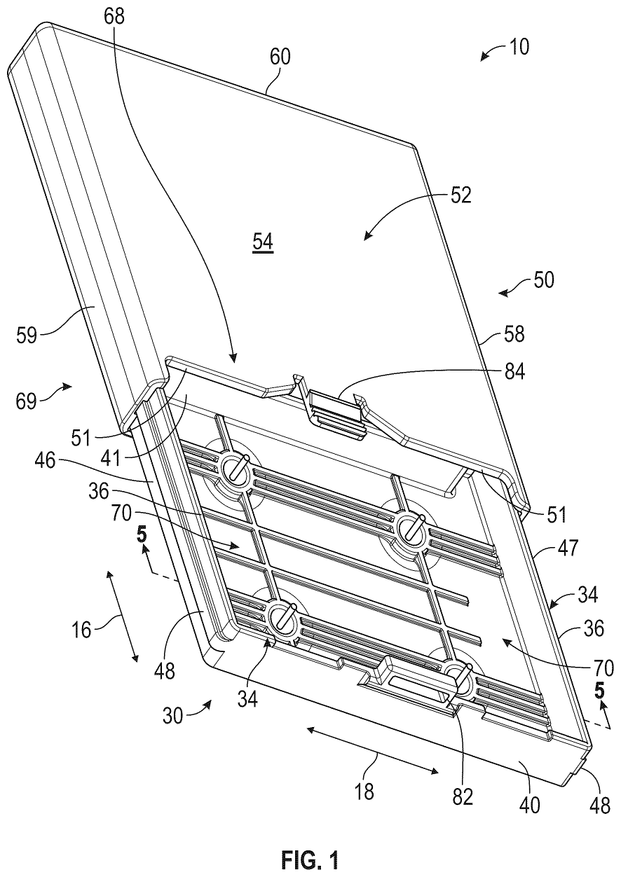

Further in this regard, for example, and referring to FIGS. 1, 3, 5, 9 and 10, there is a ridge 48 and a secondary-grooved channel 66 in between each of the base width-walls 46 and 47 and the cover width-walls 58 and 59. Additionally, preferably, the ridge 48 is sized and configured for mating sliding engagement with the secondary-grooved channel 66 adjacent thereto. While ridge 48 is shown on base 30 and secondary-grooved channel 66 is on cover 50, such can be reversed as desired by the user in conjunction with the disclosure here and what one of ordinary skill in the art would know to do, and still be able to readily practice the disclosure.

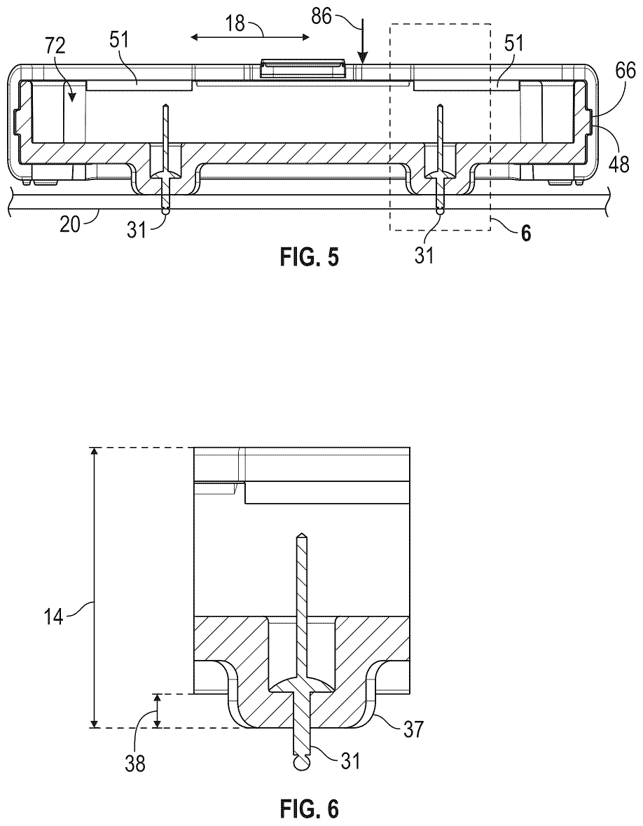

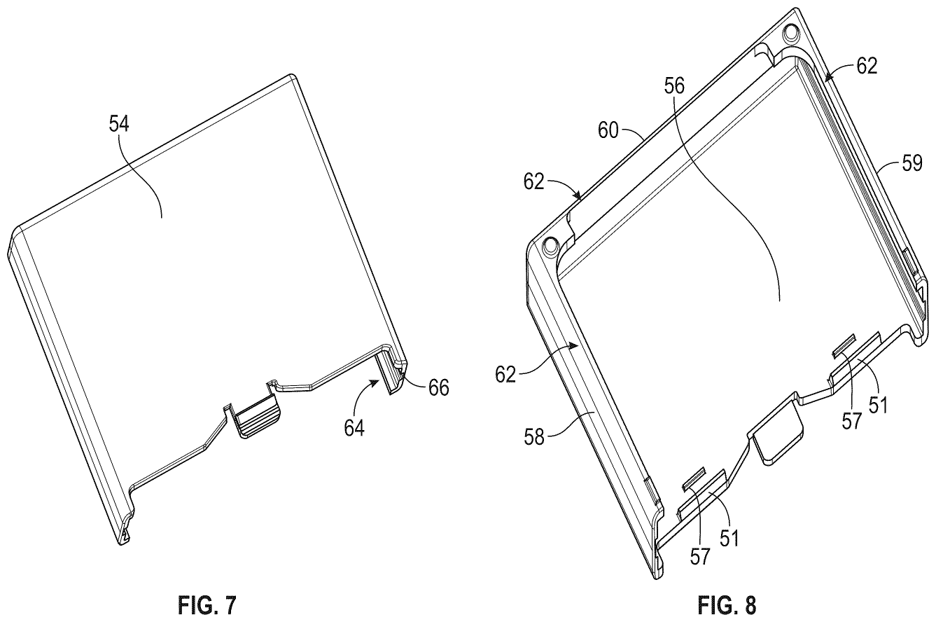

Further building upon the tight capability window teaching of this disclosure, and see FIGS. 3 and 5 for example, preferably a latch edge portion 68 of the cover 50 is in a press-fit relationship with an upper edge 34 of wall 40 of the pair of spaced apart base length-walls located adjacent to the latch edge portion 68 of the cover 50 when the cover is in the temporarily locked position 12. As such, this helps form a temporarily seal (e.g., by a friction fit engagement of the adjacent structures for some or all of their adjacent surfaces) between an inside surface of the cover that is adjacent to upper edge 34 of the base (i.e., or helps reduce the gap between the cover and the base to better prevent water from entering the storage chamber) when the cover is in the temporarily locked position. Additionally, preferably the latch 80 creates a force 86 to further help form the press-fit relationship between the cover 50 the base 30. That is, the lever 84 seated in the catch 82 can be configured to urge the cover wall 54 toward the base 30 and thereby form and/or enhance the press-fit relationship between upper edge 34 of walls 40, 41, 46, and/or 47, with adjacent inside surfaces of cover wall 54.

Additionally, or alternately, upper edge 34 of the four perimeter walls can form an apex 36 (FIG. 9 for best clarity, but seen in other FIGS. too), such as an inverted U or V shaped upper edge. Being of a thinner cross-section than the remainder of walls 40, 41, 46, and/or 47, apex 36 can further help with the press-fit relationship. Further in this regard, preferably the apex 36 seats against an inner surface 56 of the cover wall 54 when the cover is in the temporarily locked position 12. Still additionally, preferably the apex seats against the inner surface of the cover wall in the press-fit relationship to even better environmentally seal the storage chamber from elements outside the chamber.

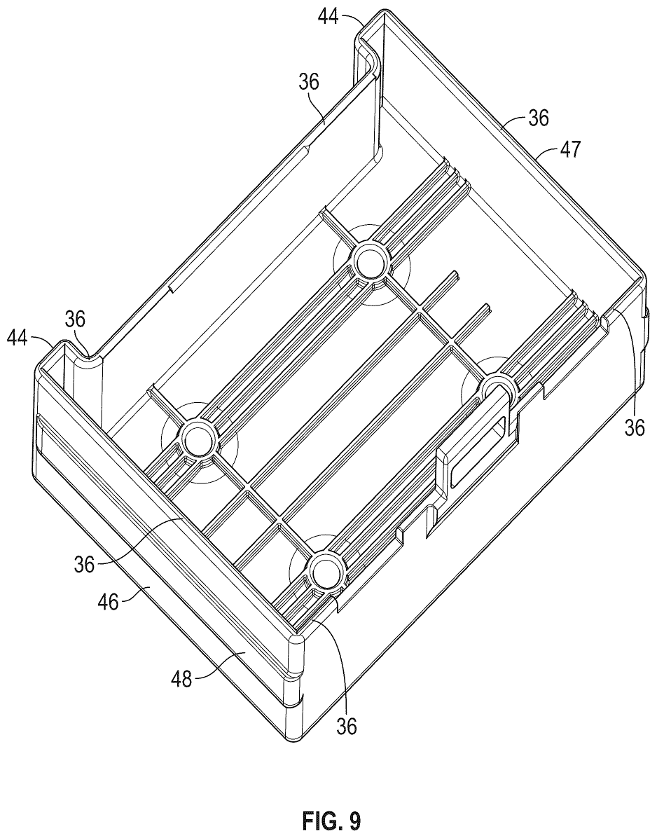

Yet still additionally, or alternately, preferably the cover and the base once placed together to form the document storage chamber 70 cannot be completely separated without distorting a portion of either the cover or the base. For example, and referring to FIGS. 4-6 and 8, cover 50 can have at least one, and preferably two, ridge(s) 51 projecting downwardly from the cover at the front edge of the cover. Ridge(s) 51 can be sized and configured to interact with the back base length-wall 41. That is, cover 50 at its front edge can have enough flexibility for the ridge(s) 51 to pass over the upper edge of back base length-wall 41 when assembling together cover 50 with base 30, but then once the cover is located together with and over the base, the ridge(s) 51 prevents the cover from being completely separated from, i.e., slide off of, base 30 because the ridge(s) 51 will not pass back over the upper edge 34 of back base length-wall 41, unless some portion of the base or cover is distorted, i.e., causing the container 10 to be damaged and not function thereafter as well as desired.

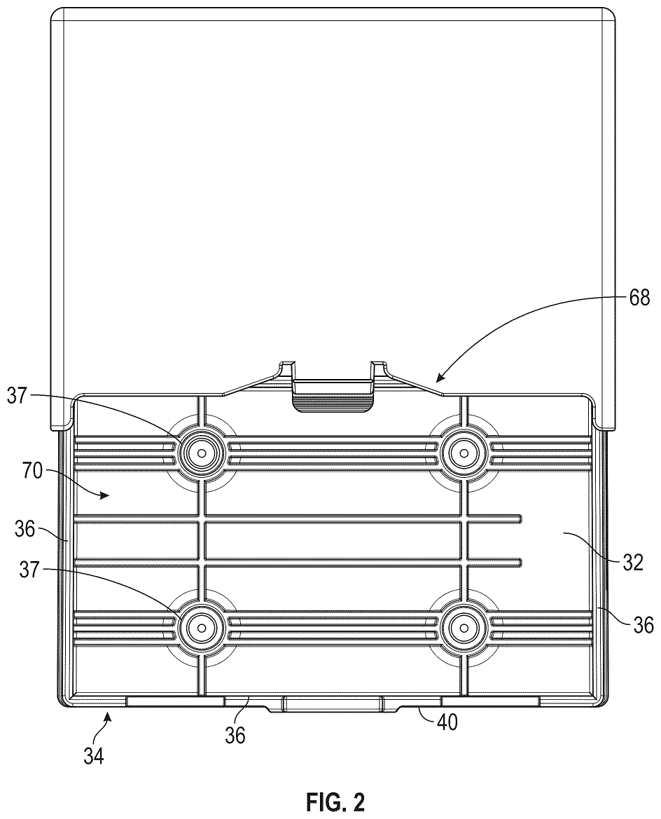

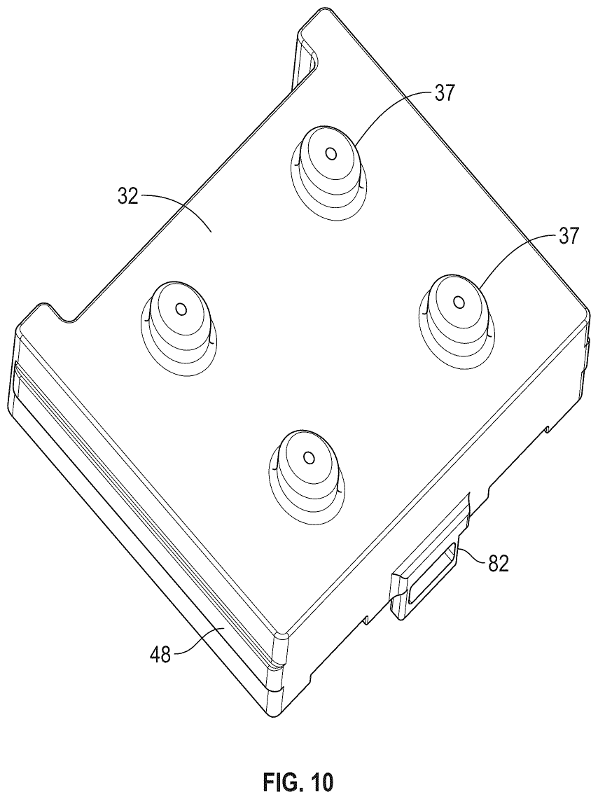

Turning to other features of the disclosure, the lever 84 can be capable of being separated from the catch 82 to unlock the latch, and preferably by a user's single-hand operation. In this way, the user's fingers on one hand can push the lever 84 down and under the catch 82, while simultaneously using those same fingers to push the lever back through the catch 82, as the cover slides toward the open position to gain access to the storage chamber 70. Additionally, or alternately, the base back length-wall 41, of the pair of spaced apart base length-walls 40 and 41, has a leg protrusion 44 (FIGS. 9 and 10) on at least one end of the base length-wall. The back wall 41 is configured to maintain connection between the cover 50 and the base 30 when the cover is fully opened. That is, a flat back edge between leg protrusions 44 on wall 41 (and thus effectively eliminating leg protrusions 44) could result in the cover either sliding completely off or not opening as much as desired, and thus impairing desired use. Further in this regard, and for the open most position of the cover when desired (e.g., FIGS. 1 and 2), the cover open position can include a temporarily retained-open position such that the cover 50 is incapable of sliding into the temporarily locked position under a weight of the cover alone if the cover is acted upon by gravity alone from the cover open position, such as when fully open. For example, there can be at least one, and preferably two, cover protrusion(s) 57 projecting from the inner surface of the cover toward the base, such that protrusion(s) 57 interacts with upper edge 34 of the base wall 41 located between legs protrusions 44. This interaction can be an interference relationship between upper edge 34 and protrusion(s) 57 that temporarily displaces protrusion 57 over edge 34 as the cover 30 goes to open position 69 and is fully opened where ridge(s) 51 then prevents further opening of the cover relative to the base, which also prevents separation of the cover from off the back end of base 30 after the base and the cover have first been assembled together. That is, in the fully open and temporarily retained-open position, the protrusion(s) 57 is on the outside of upper edge 34 and the ridge(s) 51 that prevents the cover from being separated from the base is on the inside of upper edge 34. Unless and until a force plus gravity is applied to the back edge of the fully open cover, does the cover then move toward the temporarily locked position and out of the temporarily retained-open position. Related to this, the cover protrusion(s) 57 does not protrude as much as ridge 51 from the cover toward the base because of the different desired function of each of 51 and 57 as described above.

Yet additionally, or alternately, when the container is vertically mounted in a horizontal oriented direction, and the cover is not in the temporarily retained-open position described above, preferably the cover is capable of sliding into the temporarily locked position under a weight of the cover alone as the cover is acted upon by gravity from a cover open position 69 (i.e., closed just enough to not be in the temporarily retained-open position) to the temporarily locked position 12. Further in this regard, even more preferably the cover open position is where the cover is covering anywhere from 50% to 10% of the document storage chamber, more preferably anywhere from 60% to 10% of the document storage chamber and most preferably anywhere from 70% to 10% of the document storage chamber. Further in this regard, and also directed to the self-closing feature of the container, the stroke length needed to cause the cover to close and move into the temporarily locked position under the force of gravity alone (i.e., and without need for a spring, piston, push or other external force), is preferably no more than 50% of the length of the base width-walls 46 and 47, more preferably no more than 40% of the length of the base width-walls 46 and 47 and most preferably no more than 30% of the length of the base width-walls 46 and 47. So, while the full distance of walls 46 and 47 could be used, preferably less than that full length is needed to more easily ensure the cover will be moved into the temporarily locked position when the user is done placing or accessing documents in the storage chamber 70 and then the user releases cover 50 causing gravity to move it into the closed position (e.g., FIGS. 3 and 4).

Additional discussion of the disclosure in various aspects now follows:
A. A vertically mountable and horizontally orientable document container for mounting on a surface. The container includes a base, a cover, and a latch. The base has a base wall and four perimeter walls extending away from the base wall and including a pair of spaced apart base length-walls located in between a pair of spaced apart base width-walls, the base is configured for attachment to the surface within an outline of the four perimeter walls. The cover has a cover wall and three perimeter walls extending away from the cover wall with a pair of cover width-walls spaced apart by a cover length-wall therebetween, the cover is sized and configured to slidingly engage with a perimeter of the base and matingly fit over the base to form a document storage chamber between the base and the cover. Each of the cover three perimeter walls has a bottom edge portion extending toward a center of the cover and forming a primary-grooved channel in each of the three perimeter walls. The base width-walls are sized and configured for fitted-sliding engagement with the primary-grooved channel in each of the cover width-walls. The latch is formed by the base and the cover and includes a catch and a lever. The lever snap-fits together with the catch to secure the cover in a temporarily locked position when the cover is located covering the base and providing an environmentally-secure zone in the document storage chamber.
B. The document container of any of the prior aspects, further including a ridge and a secondary-grooved channel in between each of the base width-walls and the cover width-walls where the base width-walls are adjacent to the cover width-walls, and the ridge is sized and configured for mating sliding engagement with the secondary-grooved channel.
C. The document container of any of the prior aspects, wherein a latch edge portion of the cover is in a press-fit relationship with an upper edge of one of the pair of spaced apart base length-walls located adjacent to the latch edge portion of the cover when the cover is in the temporarily locked position.
D. The document container of any of the prior aspects, wherein the latch creates a force to form the press-fit relationship between the cover and the base.
E. The document container of any of the prior aspects, wherein the lever is capable of being separated from the catch to unlock the latch by a user's single-hand operation.
F. The document container of any of the prior aspects, wherein the cover and the base once placed together to form the document storage chamber cannot be completely separated without distorting a portion of either the cover or the base.
G. The document container of any of the prior aspects, wherein an upper edge of the four perimeter walls forms an apex.
H. The document container of any of the prior aspects, wherein the apex seats against an inner surface of the cover wall when the cover is in the temporarily locked position.
I. The document container of any of the prior aspects, wherein the apex seats against the inner surface of the cover wall in a press-fit relationship.
J. The document container of any of the prior aspects, wherein a base back length-wall of the pair of spaced apart base length-walls has a leg protrusion on at least one end of the base back length-wall.
K. The document container of any of the prior aspects, wherein a thickness of the container is in the range of 30 mm to 50 mm when the cover is in the temporarily locked position.
L. The document container of any of the prior aspects, wherein when the container is vertically mounted in a horizontal oriented direction the cover is capable of sliding into the temporarily locked position under a weight of the cover alone as the cover is acted upon by gravity from a cover open position to the temporarily locked position.
M. The document container of any of the prior aspects, wherein the cover open position comprises the cover covering anywhere from 10% to 70% of the document storage chamber.
N. The document container of any of the prior aspects, wherein the cover open position comprises a temporarily retained-open position such that the cover is incapable of sliding into the temporarily locked position under a weight of the cover alone if the cover is acted upon by gravity alone from a cover open position to the temporarily locked position.
O. The document container of any of the prior aspects, wherein the base has at least one foot and the foot is shaped and configured to create a gap between a bottom edge portion of the cover and the surface.

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The invention includes the description, examples, features, embodiments, and drawings disclosed; but it is not limited to such description, examples, features, embodiments, or drawings. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. As used herein, the word “about” and other similar words of approximation, are defined to include a range of measure and/or operation that is plus and minus ten percent from the stated amount and would be well understood with the disclosure here and what one of ordinary skill in the art would know to do to readily practice the disclosure without undue experimentation. Modifications and other embodiments that are readily apparent to a person of ordinary skill in the applicable art, are modifications and other embodiments that are intended to be and deemed to be within the scope of the invention.

What is claimed is:

1. A vertically mountable and horizontally orientable document container for mounting on a surface comprising:
a base comprising a base wall and four perimeter walls extending away from the base wall and including a pair of spaced apart base length-walls located in between a pair of spaced apart base width-walls, wherein the base is configured for attachment to the surface within an outline of the four perimeter walls;
a cover comprising a cover wall and three perimeter walls extending away from the cover wall with a pair of cover width-walls spaced apart by a cover length-wall therebetween, wherein the cover is sized and configured to slidingly engage with a perimeter of the base and matingly fit over the base to form a document storage chamber between the base and the cover;
each of the three perimeter walls of the cover has a bottom edge portion extending toward a center of the cover and forming a primary-grooved channel in each of the three perimeter walls;
the base width-walls being sized and configured for fitted-sliding engagement with the primary-grooved channel in the cover width-walls; and
a latch formed by the base and the cover that comprises a catch and a lever, wherein the lever snap-fits together with the catch to secure the cover in a temporarily locked position when the cover is located covering the base and providing an environmentally-secure zone in the document storage chamber.

2. The document container of claim 1, further including a ridge and a secondary- grooved channel in between each of the base width-walls and the cover width-walls where the base width-walls are adjacent to the cover width-walls, and the ridge is sized and configured for mating sliding engagement with the secondary-grooved channel.

3. The document container of claim 1, wherein a latch edge portion of the cover is in a press-fit relationship with an upper edge of one of the pair of spaced apart base length-walls located adjacent to the latch edge portion of the cover when the cover is in the temporarily locked position.

4. The document container of claim 3, wherein the latch creates a force to form the press-fit relationship between the cover and the base.

5. The document container of claim 1, wherein the lever is capable of being separated from the catch to unlock the latch by a user's single-hand operation.

6. The document container of claim 1, wherein the cover and the base once placed together to form the document storage chamber cannot be completely separated without distorting a portion of either the cover or the base.

7. The document container of claim 1, wherein an upper edge of the four perimeter walls of the base forms an apex.

8. The document container of claim 7, wherein the apex seats against an inner surface of the cover wall when the cover is in the temporarily locked position.

9. The document container of claim 7, wherein the apex seats against the inner surface of the cover wall in a press-fit relationship.

10. The document container of claim 1, wherein a base back length-wall of the pair of spaced apart base length-walls has a leg protrusion on at least one end of the base back length-wall.

11. The document container of claim 1, wherein a thickness of the container is in the range of 30 mm to 50 mm when the cover is in the temporarily locked position.

12. The document container of claim 1, wherein when the container is vertically mounted in a horizontal oriented direction the cover is capable of sliding into the temporarily locked position under a weight of the cover alone as the cover is acted upon by gravity from a cover open position to the temporarily locked position.

13. The document container of claim 1, wherein the cover open position comprises the cover covering anywhere from 10% to 70% of the document storage chamber.

14. The document container of claim 1, wherein the cover open position comprises a temporarily retained-open position such that the cover is incapable of sliding into the temporarily locked position under a weight of the cover alone if the cover is acted upon by gravity alone from a cover open position to the temporarily locked position. 15 The document container of claim 1, wherein the base has at least one foot and the foot is shaped and configured to create a gap between a bottom edge portion of the cover and the surface.

16. A vertically mountable and horizontally orientable document container for mounting on a surface comprising:
a base comprising a base wall and four perimeter walls extending away from the base wall and including a pair of spaced apart base length-walls located in between a pair of spaced apart base width-walls, wherein the base is configured for attachment to the surface within an outline of the four perimeter walls;
a cover comprising a cover wall and three perimeter walls extending away from the cover wall with a pair of cover width-walls spaced apart by a cover length-wall therebetween, wherein the cover is sized and configured to slidingly engage with a perimeter of the base and matingly fit over the base to form a document storage chamber between the base and the cover;
each of the three perimeter walls of the cover has a bottom edge portion extending toward a center of the cover and forming a primary-grooved channel in each of the three perimeter walls;
the base width-walls being sized and configured for fitted-sliding engagement with the primary-grooved channel in the cover width-walls;
a latch formed by the base and the cover that comprises a catch and a lever, wherein the lever snap-fits together with the catch to secure the cover in a temporarily locked position when the cover is located covering the base and providing an environmentally-secure zone in the document storage chamber;
a ridge and a secondary-grooved channel in between each of the base width-walls and the cover width-walls where the base width-walls are adjacent to the cover width-walls, and the ridge is sized and configured for mating sliding engagement with the secondary-grooved channel; and
a latch edge portion of the cover is in a press-fit relationship with an upper edge of one of the pair of spaced apart base length-walls located adjacent to the latch edge portion of the cover when the cover is in the temporarily locked position.

17. The document container of claim 16, wherein the latch creates a force to form the press-fit relationship between the cover and the base.

18. The document container of claim 16, wherein an upper edge of the four perimeter walls of the base forms an apex and the apex seats against the inner surface of the cover wall in a press-fit relationship.

19. The document container of claim 16, wherein a base back length-wall of the pair of spaced apart base length-walls has a leg protrusion on at least one end of the base back length-wall.

20. The document container of claim 16, wherein when the container is vertically mounted in a horizontal oriented direction the cover is capable of sliding into the temporarily locked position under a weight of the cover alone as the cover is acted upon by gravity from a cover open position to the temporarily locked position, and wherein the cover open position comprises the cover covering anywhere from 10% to 70% of the document storage chamber.
